(19) United States
(12) Patent Application Publication
(10) Pub. No.: US 2012/0279991 A1
(43) Pub. Date: Nov. 8, 2012

(54) TOOL-LESS QUICK-CHANGE VALVING ROD

(75) Inventors: John S. Lihwa, Willowick, OH (US); Michael A. Cryer, Massillon, OH (US); Heath I. McCartney, Massillon, OH (US); Charles E. Moser, Belout, OH (US)

(73) Assignee: GRACO MINNESOTA INC., Minneapolis, MN (US)

(21) Appl. No.: 13/514,325

(22) PCT Filed: Dec. 8, 2010
(86) PCT No.: PCT/US10/03119

§ 371 Date: Jun. 7, 2012

Related U.S. Application Data
(60) Provisional application No. 61/267,512, filed on Dec. 8, 2009.

(51) Int. Cl. B67D 7/78; B65D 83/00

(52) U.S. Cl. 222/145.2; 222/145.5

(57) ABSTRACT

A dispensing gun has a mix head, a purge rod, an actuator, and a joint. The mix head has two fluid component inlets and a mixing chamber that combines the two fluid components. The purge rod is slidably positioned in the mix head and has a forward position for preventing flow of the two fluid components, and a rearward position for allowing flow of the two fluid components. The purge rod is moved by an actuator which is connected to the purge rod by a joint having a head and a cavity.

### CROSS-REFERENCE TO RELATED APPLICATION

This application claims priority under 35 U.S.C. §120 to U.S. provisional application Ser. No. 61/267,512, entitled “TOOL-LESS QUICK CHANGE VALVING ROD,” filed Dec. 8, 2009 by inventors John Lihwa, Michael Cryer, Heath McCartney, and Charles Moser, the contents of which are incorporated by this reference.

### BACKGROUND

The present invention relates to plural component dispensing devices, and, more particularly, to the connection of a mechanical purge rod to an actuator in a plural component dispensing gun.

Typically, plural components of the type relating to the present invention comprise a resin component which is chemically inert in isolated form and an isocyanate material which is also chemically inert in isolated form. When isocyanate and resin are combined, an immediate chemical reaction begins taking place that results in the cross-linking, curing, and solidification of the mixture. Therefore, the two components are routed separately in the dispensing gun up until near the tip, where they are mixed and dispensed out of the tip. Between dispensing shots of mixture, the mixing area and tip of the dispensing gun must be cleared of mixture or else the mixture will solidify and render the dispensing gun inoperable. Therefore, a purge rod is used to evacuate the components from the mixing area and tip of the dispensing gun. Because of the high (and increasing) viscosity of the solidifying plural mixture, the purge rod can become fouled. This requires the dispensing gun to be disassembled on a regular basis for routine cleaning, which can be a time consuming and complicated process.

### SUMMARY

According to one embodiment of the present invention, a dispensing gun has a mix head, a purge rod, an actuator, and a joint. The mix head has two fluid component inlets and a mixing chamber that combines the two fluid components. The purge rod is slidably positioned in the mix head and has a forward position for preventing flow of the two fluid components, and a rearward position for allowing flow of the two fluid components. The purge rod is moved by an actuator which is connected to the purge rod by a joint having a head and a cavity.

In another embodiment, a dispensing gun has a handle, a cylinder attached to the handle, and a reciprocating actuator inside the cylinder. There is also a dispense tip attached to the cylinder with a purge rod slidably positioned inside the dispense tip. The purge rod is connected to the reciprocating actuator with a joint that has a head and a cavity.

### BRIEF DESCRIPTION OF THE DRAWINGS

FIG. 1 is a side elevation view of a dispensing gun.

FIG. 2 is a rear elevation view of the dispensing gun of FIG. 1.

FIG. 3A is a top cross-section view of a mix head along line 3-3 in FIG. 1, with the mix head dispensing a plural component mix and a purge rod in a rearward position.

FIG. 3B is a top cross-section view of the mix head along line 3-3 in FIG. 1, with the mix head not dispensing the plural component mix and the purge rod in a forward position.

FIG. 4A is a side cross-section view of the dispensing gun along line 4-4 in FIG. 2, showing an actuator shaft joined to the purge rod.

FIG. 4B is an enlarged side cross-section view of a cylinder and the mix head of FIG. 4A, showing the actuator shaft joined to the purge rod.

FIG. 5A is an exploded bottom view of the purge rod and the actuator shaft showing components of a joint between the purge rod and the actuator shaft.

FIG. 5B is an exploded side cross-section view of the purge rod and the actuator shaft along line 5B in FIG. 5A, showing the components of the joint between the purge rod and the actuator shaft.

### DETAILED DESCRIPTION

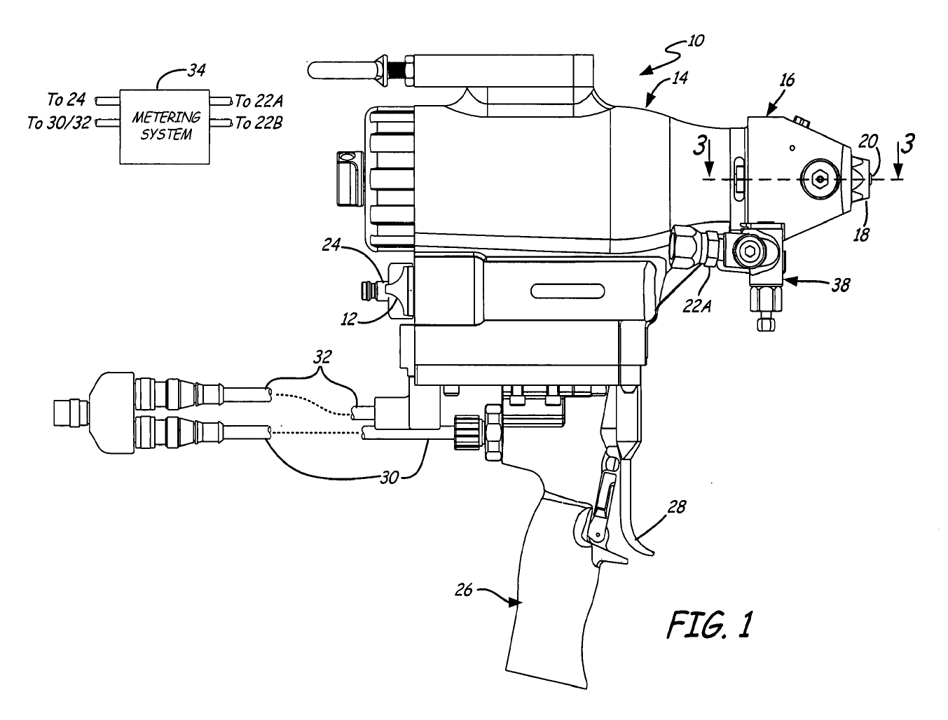

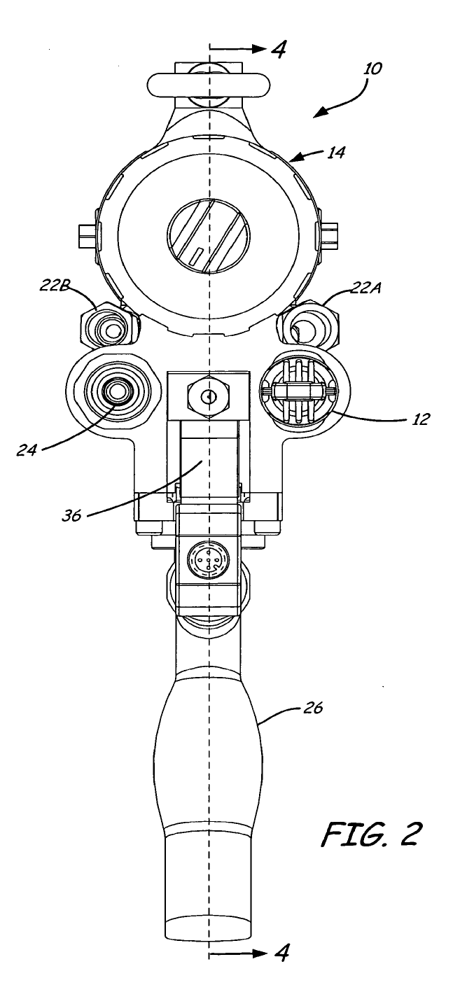

Dispensing gun 10 is shown in FIG. 1 in a side elevation view and in FIG. 2 in a rear elevation view. Dispensing gun 10 includes cartridge 12, cylinder 14, mix head 16, tip 18, purge rod 20, first and second component inlets 22A and 22B, gas inlet 24, handle 26, trigger 28, control out 30, control in 32, solenoid 36, and component manifold 38. Metering system 34, which is connected to dispensing gun 10 is also shown. FIGS. 1-2 will be discussed together.

Mix head 16 is mounted to the front end of cylinder 14 and includes tip 18, purge rod 20, and component manifold 38. First component inlet 22A and second component inlet 22B are connected to component manifold 38. Component manifold 38 is connected to mix head 16 near the rear of mix head 16. Tip 18 is connected to the front of mix head 16, and purge rod 20 is slidably positioned within mix head 16 and tip 18. Handle 26 is mounted to the bottom side of cylinder 14, and includes trigger 28 and control out 30. Trigger 28 is pivotally connected to handle 26, and control out 30 is attached to an upper rear portion of handle 26.

Cylinder 14 has cartridge 12, gas inlet 24, control in 32, and solenoid 36. Gas inlet 24 and cartridge 12 are attached to the rear of cylinder 14. Solenoid 36 is attached to the bottom side of cylinder 14, between cylinder 14 and handle 26. Attached to the rear of solenoid 36 is control in 32.

Metering system 34 is fluidly connected to dispensing gun 10 through first component inlet 22A, second component inlet 22B, and gas inlet 24. Metering system 34 is electrically connected to dispensing gun 10 through control out 30 and control in 32. Pressurized gas is provided by metering system 34 at gas inlet 24 that is used, for one example, to pressurize cartridge 12. Cartridge 12 contains lubricant that is forced through cylinder 14 into mix head 16, where it lubricates purge rod 20.

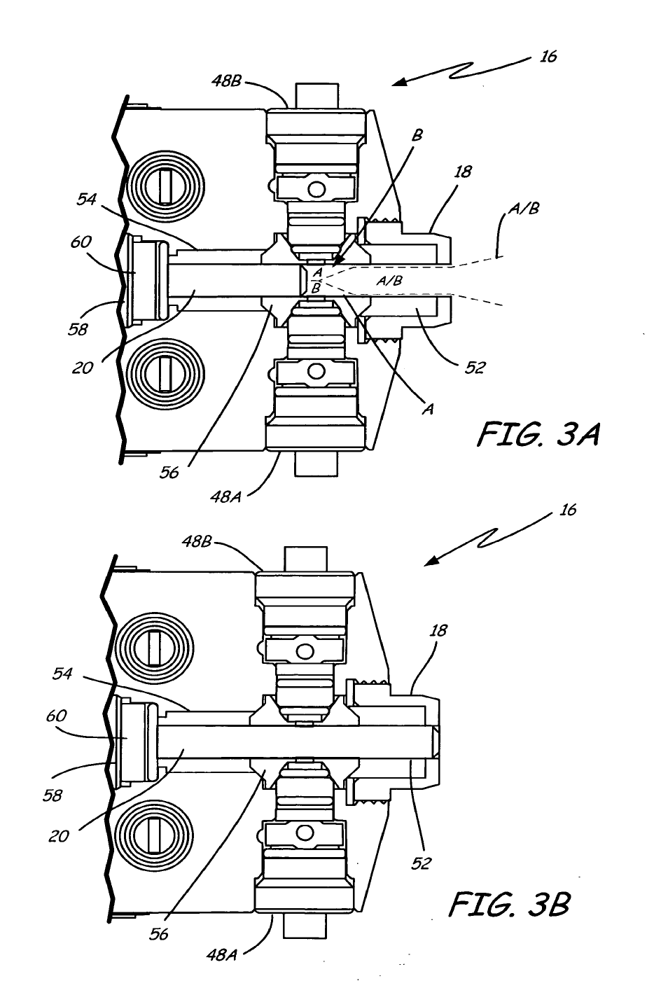

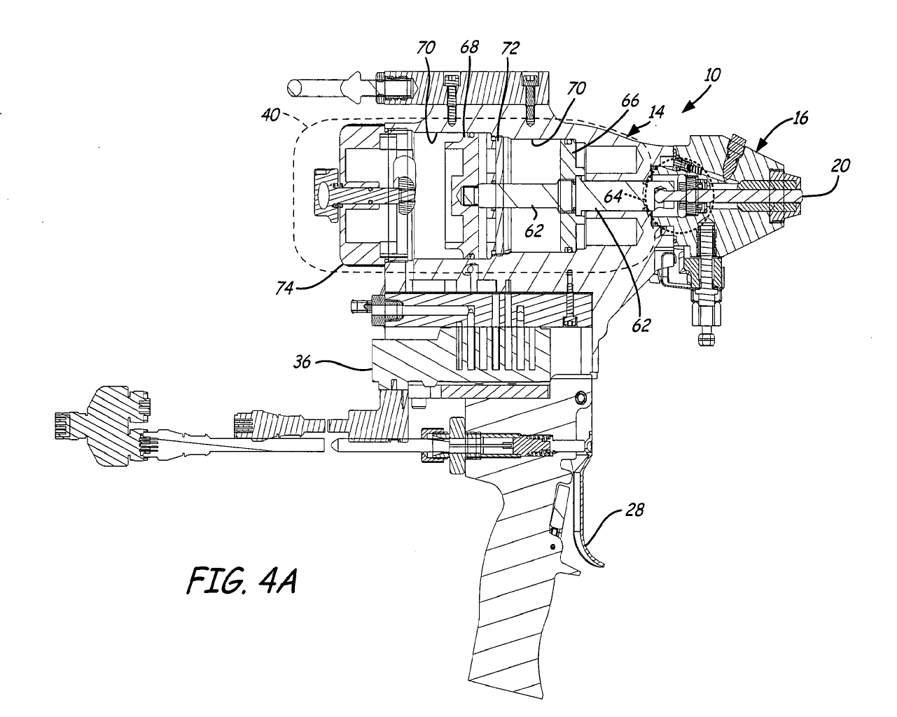

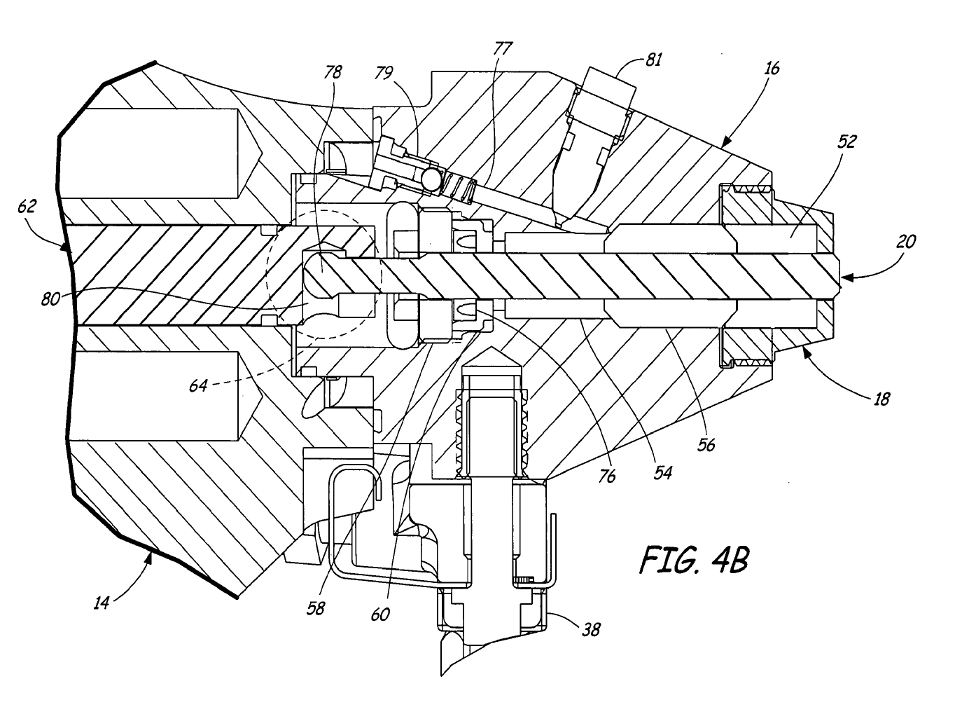

Dispensing gun 10 operates when a user pulls trigger 28. An electrical signal is sent through control out 30 to metering system 34. Metering system 34 then sends the appropriate signal to solenoid 36 through control in 32. Solenoid 36 controls a pneumatically operated actuator 40 (as shown later in FIG. 4) for dispensing gun 10. In one embodiment, solenoid 36 delivers gas from metering system 34 to power actuator 40 inside cylinder 14. Actuator 40 moves purge rod 20 to the rear (to the left as shown in FIG. 1), dispensing plural component mix A/B (as described further with the discussion of FIG. 3A). When trigger 28 is released, solenoid 36 is controlled to reverse the movement of actuator 40. This action moves purge rod 20 forward (to the right as shown in FIG. 1), which stops the flow of plural component mix A/B. However, in an alternative embodiment, solenoid 36 is replaced with a mechanical spool valve. Such a spool valve is mechanically controlled by the user pulling or releasing trigger 28. In such an embodiment, the spool valve controls actuator 40. Additionally, due to the mechanical structure in this embodiment, control out 30 and control in 32 are not required.

The components and configuration of dispensing gun 10 as shown in FIGS. 1-2 allow for plural component mix A/B to be dispensed from dispense gun 10. This occurs in part because purge rod 20 is joined to actuator 40, and actuator 40 moves purge rod 20 to dispense or prevent dispensing of plural component mix A/B. The present application relates to the joining of purge rod 20 and actuator 40.

Shown in FIGS. 3A-3B are a top cross-section views of mix head 16 along line 3-3 in FIG. 1, with mix head 16 dispensing plural component mix A/B in FIG. 3A and not dispensing in FIG. 3B. Shown in FIGS. 3A-3B are mix head 16, tip 18, purge rod 20, plural component mix A/B, first component A, second component B, first orifice 48A, second orifice 48B, bearing sleeve 52, lubricant chamber 54, mix module 56, packing nut 58, and packing housing 60.

In FIG. 3A, first orifice 48A and second orifice 48B are attached to their respective bores in opposite sides of mix head 16. Orifices 48A and 48B are attached and fluidly communicate with component inlets 22A and 22B, respectively (as shown in FIG. 2). Positioned in the interior of mix head 16 and between first orifice 48A and second orifice 48B is mix module 56. As stated previously, tip 18 is attached to the front of mix head 16, with bearing sleeve 52 positioned inside tip 18.

Behind mix module 56 is lubricant chamber 54. Lubricant chamber 54 is a cavity in mix head 16 containing lubricant, such as provided by cartridge 12 of FIG. 1, that is bounded by mix module 56 in the front and packing housing 60 in the rear. Packing housing 60 is positioned within mix head 16 and is captured by packing nut 58, with packing nut 58 being attached inside mix head 16. Purge rod 20 is slidably positioned inside mix head 16, specifically within tip 18, bearing sleeve 52, mix module 56, lubricant chamber 54, packing housing 60 and packing nut 58.

Mix head 16 is shown dispensing plural component mix A/B. The dispensing occurs because first component A and second component B are pressurized by metering system 34 (shown in FIG. 1). First component A and second component B are transported from metering system 34, through first component inlet 22A and second component inlet 22B, respectively, and to first orifice 48A and second orifice 48B, respectively. When purge rod 20 is retracted towards the rear of dispensing gun 10, the pressure forces first component A and second component B from first orifice 48A and second orifice 48B into mix module 56, respectively. First component A and second component 48B then mix and form plural component mix A/B, which begins to solidify. However, plural component mix A/B is dispensed out of dispensing gun 10 through bearing sleeve 52 and tip 18 prior to solidification.

In FIG. 3B, purge rod 20 is shown in a forward position. In this position, purge rod 20 prevents flow of first component A and second component B from first orifice 48A and second orifice 48B, respectively. In addition, when purge rod 20 was moved forward from the rear (as shown in FIG. 3A), purge rod 20 forced out all of first component A, second component B, and plural component mix A/B that was in mix module 56, bearing sleeve 52, and tip 18.

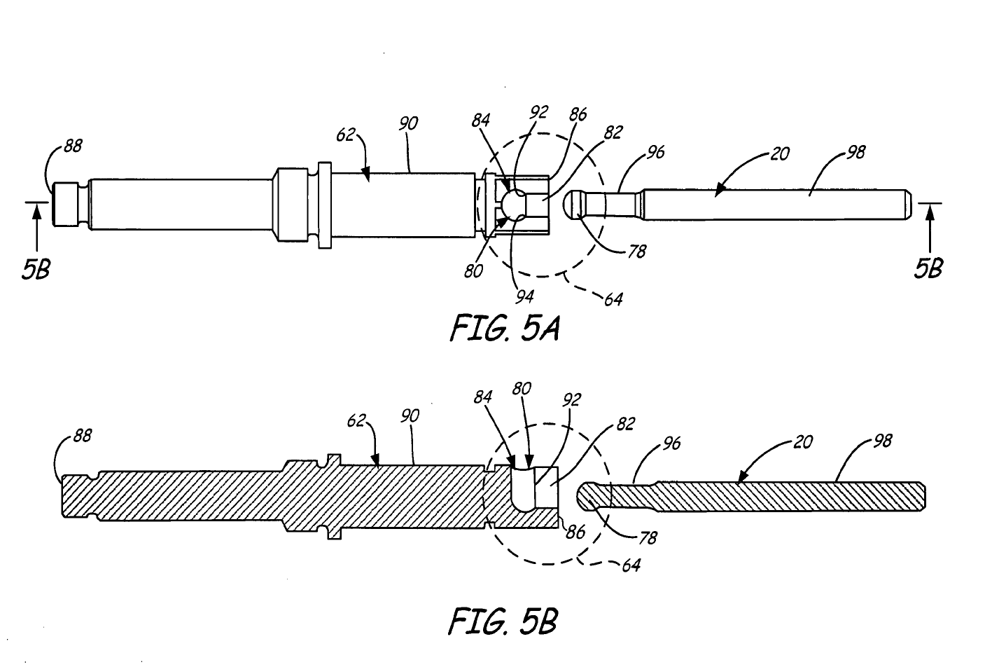

The components and configuration of dispensing gun 10 as shown in FIG. 3 allow for first component A and second component B to mix and form plural component mix A/B, which is dispensed out of tip 18. In addition to stopping the flow of first component A and second component B, the forward motion of purge rod 20 purges dispensing gun 10 of solidifying plural component mix A/B. This prevents dispensing gun 10 from being clogged by hardened plural component mix A/B. As will be discussed further with FIGS. 4A-5B, motion of purge rod 20 is provided by actuator 40.

Shown in FIG. 4A is a side cross-section view of dispensing gun 10 along line 4-4 in FIG. 2. Shown in FIG. 4A are dispensing gun 10, cylinder 14, mix head 16, purge rod 20, trigger 28, solenoid 36, actuator 40, and joint 64. Actuator 40 includes actuator shaft 62, front piston 66, rear piston 68, cylinder bore 70, bulkhead 72, and cylinder cap 74.

As stated previously, mix head 16 is attached to the front of cylinder 14, while actuator 40 is inside cylinder 14. Purge rod 20 is slidably positioned in mix head 16 and is connected to actuator 40. Specifically, purge rod 20 is joined to actuator shaft 62 at joint 64. Near the middle of actuator shaft 62, actuator shaft 62 is connected to front piston 66. At the rear end of actuator shaft 62, actuator shaft 62 is connected to rear piston 68. Both front piston 66 and rear piston 68 are slidably positioned within cylinder bore 70. Bulkhead 72 is connected to cylinder bore 70 and is located between front piston 66 and rear piston 68. Actuator shaft 62 is slidably positioned in an aperture in bulkhead 72. At the rear end of cylinder bore 70, cylinder cap 74 is attached to cylinder 14.

In the illustrated embodiment, actuator 40 is a pneumatically powered dual piston actuator. Solenoid 36 allows pressurized gas provided by metering system 34 to enter cylinder bore 70 in front of front piston 66 and in front of rear piston 68 (but behind bulkhead 72) when trigger 28 is pulled. The pressure forces front piston 66 and rear piston 68 to move rearward, which moves actuator shaft 62 rearward in a direction following the longitudinal axis of actuator shaft 62. Because actuator shaft 62 is joined to purge rod 20 at joint 64, purge rod 20 is pulled to the rear along the longitudinal axis of purge rod 20. This allows for plural component mix A/B to be dispensed from dispensing gun 10.

When trigger 28 is released, solenoid 36 relieves the pressure in front of front piston 66 and rear piston 62. Solenoid also directs pressurized gas to cylinder bore 70 behind front piston 66 (but in front of bulkhead 72) and behind rear piston 68 (but in front of cylinder cap 74). The pressure forces front piston 66, rear piston 68, and actuator shaft 62 axially forward, which pushes purge rod 20 forward. This action ceases flow of plural component mix A/B from dispensing gun 10.

The components and configuration of dispensing gun 10 as shown in FIG. 4B allow for actuator 40 to be actuated pneumatically. In addition, the movement of actuator 40 is translated to purge rod 20 through actuator shaft 62 and joint 64. This allows for plural component mix A/B to be dispensed or prevented from being dispensed from dispensing gun 10.

Shown in FIG. 4A is one embodiment of dispensing gun 10, to which there are alternative embodiments. For example, actuator 40 can have only one piston connected to actuator shaft 62. For another example, actuator 40 can be hydraulically powered and use pressurized liquid to translate force to front piston 66 and rear piston 68. For a more general example, different types of actuator 40 with various actuator shafts 62 can be used to move purge rod 20. The present invention relates to the joining of purge rod 20 and actuator shaft 62 at joint 64.

Shown in FIG. 4B is an enlarged side cross-section view of cylinder 14 and mix head 16 in FIG. 4A. Shown in FIG. 4B are cylinder 14, mix head 16, purge rod 20, component manifold 38, actuator shaft 62, joint 64, head 78, and cavity 80. Mix head 16 includes tip 18, bearing sleeve 52, lubricant chamber 54, mix module 56, packing nut 58, packing housing 60, u-cup seal 76, lubricant pathway 77, check valve 79, and bleed port screw 81.

The parts and connections of mix head 16 are as described with FIGS. 3A-3B, with some additional features shown in FIG. 4B. For example mix head 16 is attached to and inset into the front of cylinder 14. Mix head 16 also includes u-cup seal 76, which is positioned between packing nut 58 and packing housing 60. Just forward of packing housing 60 is lubricant chamber 54. Lubricant chamber 54 receives lubricant from cartridge 12 (shown in FIGS. 1-2) through lubricant pathway 77. Lubricant pathway 77 has check valve 79 and bleed port screw 81, which blocks a bleed port in lubricant pathway 77. For another example, component manifold 38 is attached to the bottom of mix head 16.

As stated previously, actuator shaft 62 is slidably positioned in cylinder 14, and purge rod 20 is slidably positioned in mix head 16. Specifically, purge rod 20 is slidably positioned in tip 18, bearing sleeve 52, lubricant chamber 54, mix module 56, packing nut 58, packing housing 60, and u-cup seal 76.

Purge rod 20 is also joined with actuator shaft 62 at joint 64. Specifically, purge rod 20 has head 78 that is radially slidably positioned in cavity 80 that is part of actuator shaft 62. Cavity 80 is formed such that it penetrates through the side and end of actuator shaft 62 and is shaped such that head 78 can slide into cavity 80 in a radial direction. However, when purge rod 20 and actuator shaft 62 are joined, head 78 can not be slid out of cavity 80 axially. In addition, purge rod 20 is substantially coaxial with actuator shaft 62 when mix head 16 is in place.

The functioning of mix head 16 and purge rod 20 are as described with FIGS. 3A-4A, with some additional attributes shown in FIG. 4B. For example, when actuator shaft 62 moves along its longitudinal axis (horizontally right and left, as shown in FIG. 4B), purge rod 20 also moves along its longitudinal axis. Such axial movement by purge rod 20 occurs because the parts of mix head 16 do not allow substantial amounts of radial movement to occur. Specifically tip 18, bearing sleeve 52, mix module 56, packing nut 58, packing housing 60, and u-cup seal 76 permit axial movement of purge rod 20, but the sliding fit of these parts around purge rod 20 is too close to permit head 78 of purge rod 20 to slide radially out of cavity 80. For another example, purge rod 20 axially moves with actuator shaft 62 due to the configuration of head 78 and cavity 80. As will be explained in greater detail later with FIGS. 5A-5B, cavity 80 is shaped such that a feature of cavity 80 pulls on head 78 when actuator shaft 62 is moved rearward. Similarly, the rear of cavity 80 pushes on head 78 when actuator shaft 62 is moved forward.

While mix head 16 is shown attached to cylinder 14, mix head 16 can be detached from cylinder 14. Such detachment may be done, for example, during maintenance of dispensing gun 10. In the illustrated embodiment, mix head 16 is detached by turning mix head 16 forty-five degrees. Then mix head 16 is withdrawn from cylinder 14 until the rear of mix head 16 is forward of the front of cylinder 14. Mix head 16 can be moved downward in order to radially slide head 78 out of cavity 80, which detaches purge rod 20 from actuator shaft 62. Finally, Mix head 16 and purge rod 20 can be moved forward and away from cylinder 14.

In order for detachment of purge rod 20 to occur, actuator shaft 62 must be sufficiently forward (as shown in FIG. 4B) so that cylinder 14 is not blocking cavity 80. As previously discussed, actuator 40 moves actuator shaft 62 forward when trigger 28 is released. Thereby, actuator shaft 62 will be in a sufficiently forward position if the user has released trigger 28 prior to disassembly of dispensing gun 10.

The components and configuration of dispensing gun 10 as shown in FIG. 4B allow for purge rod 20 to be axially moved with actuator shaft 62. Furthermore, purge rod 20 can be disconnected from actuator shaft 62 when mix head 16 is detached from cylinder 14.

Depicted in FIGS. 4A-4B is one embodiment of the present invention, to which there are alternatives. For example, mix head 16 can be detached from cylinder 14 by turning mix head 16 and then moving mix head 16 forward such that purge rod 20 is no longer in mix head 16. In such an embodiment, purge rod 20 can then be moved downward, radially sliding head 78 out of cavity 80, and disconnecting purge rod 20 from actuator shaft 62. Then purge rod 20 can be moved forward and past the front of cylinder 14.

Shown in FIG. 5A is an exploded bottom view of purge rod 20 and actuator shaft 62 of FIG. 4A. Shown in FIG. 5B is an exploded side cross-section view of purge rod 20 and actuator shaft 62 along line 5B in FIG. 5A. Shown in FIGS. 5A-5B are purge rod 20, actuator shaft 62, joint 64, head 78, cavity 80, axial slot 82, socket 84, first shaft end 86, second shaft end 88, shaft surface 90, first socket edge 92, second socket edge 94, first rod shaft 96, and second rod shaft 98. The discussion of FIGS. 5A-5B will occur simultaneously.

At one end of actuator shaft 62 is first shaft end 86. At the opposite end of actuator shaft 62 is second shaft end 88. Shaft surface 90 is a surface that extends between first shaft end 86 and second shaft end 88. Shaft surface 90 is radially offset from the centerline longitudinal axis of actuator shaft 62 that extends from first shaft end 86 to second shaft end 88. Near first shaft end 86 is cavity 80. Cavity 80 is comprised of axial slot 82 and socket 84. In the illustrated embodiment, axial slot 82 is a slot that axially enters actuator shaft 62 through first shaft end 86. Axial slot 82 also radially enters actuator shaft 62 through shaft surface 90 to intersect axial slot 82. At the end of axial slot 82 that is away from first shaft end 86 is socket 84. Socket 84 is a circular hole that radially enters actuator shaft 62 through shaft surface 90. Because socket 84 is wider than axial slot 82, first socket edge 92 and second socket edge 94 are formed where axial slot 82 and socket 84 meet. The arrangement of axial slot 82 and socket 84 results in axial slot 82 being open through both first shaft end 86 and shaft surface 90. Socket 84 is open through axial slot 82 and shaft surface 90. The opening through shaft surface 90 is as wide as the diameter of socket 84. However, the opening through axial slot 82 is only as wide as the width of axial slot 82, which is narrower than the diameter of socket 84.

Purge rod 20 has head 78, first rod shaft 96, and second rod shaft 98. At one end of purge rod 20 is head 78. Connected to one side of head 78 is first rod shaft 96. First rod shaft 96 has a diameter and is connected to second rod shaft 98. Second rod shaft 98 has a diameter that is different from that of first rod shaft 96. In the illustrated embodiment, head 78 is substantially spherical and with a diameter that is larger than that of first rod shaft 96.

Purge rod 20 and actuator shaft 62 can be joined by moving purge rod 20 alongside actuator shaft 62 such that head 78 is radially aligned with socket 84. Then head 78 is slid into socket 84 while first rod shaft 96 is slid into axial slot 82 until purge rod 20 is substantially coaxial to actuator shaft 62. This insertion can occur because purge rod 20 has a complementary shape to cavity 80. However, socket 84 is slightly wider than head 78 and axial slot 82 is slightly wider than first rod shaft 96 to allow for assembly. For example, purge rod 20 is allowed to rotate within cavity 80 and can be freely displaced radially from cavity 80. Although, once assembled, purge rod 20 is restrained from moving axially with respect to actuator shaft 62.

As stated previously, when purge rod 20 and actuator shaft 62 are joined at joint 64, purge rod 20 cannot be disconnected from actuator shaft 62 by axial force or movement. This is because head 78 is wider than axial slot 82. Thereby, when actuator shaft 62 is moved rearward, first socket edge 92 and second socket edge 94 contact head 78. First socket edge 92 and second socket edge 94 transmit rearward force to head 78, which pulls purge rod 20 rearward. However, when actuator shaft 62 is moved forward, the rear portion of the inside surface of socket 84 contacts head 78. Thereby, actuator shaft 62 transmits forward force to head 78, pushing purge rod 20 forward.

The components and configuration of dispensing gun 10 as shown in FIG. 4B form a ball and socket joint, with head 78 forming the ball and cavity 80 forming the socket. This ball and socket joint can be assembled from purge rod 20 and actuator shaft 62 by using radial movement. However, once joined, purge rod 20 and actuator shaft 62 cannot be disconnected with axial movement. Therefore, axial movement of actuator shaft 62 will be translated into axial movement of purge rod 20.

Depicted in FIGS. 5A-5B is one embodiment of the present invention, to which there are alternatives. For example, purge rod 20 can have only one diameter forward of head 78 such that purge rod only has head 78 and first rod shaft 96. For another example, joint 64 can be reversed wherein head 78 is part of actuator shaft 62 and cavity 80 is part of purge rod 20. For a further example, head 78 can have a flat area on head 78 such that head 78 is not spherical. For a more general example, purge rod 20 and cavity 80 can be configured in many corresponding ways. For instance, socket 84 can be a rectangular slot and head 78 can be a disk. For an additional example, purge rod 20 can be rectangular in shape, with cavity 80 having a corresponding shape, such that purge rod 20 cannot be rotated within cavity 80. In an alternative to such an embodiment, purge rod 20 can have a key that contacts both purge rod 20 and cavity 80, preventing rotation of purge rod 20 in cavity 80.

It should be recognized that the present invention provides numerous benefits and advantages. For example purge rod 20 can be moved by actuator 40 in order to dispense or prevent dispensing of plural component mix A/B. For another example, purge rod 20 can be detached from actuator shaft 62 at joint 64 after mix head 16 is detached. Because detaching purge rod 20 does not require the use of tools, disassembly of dispensing gun 10 is quicker and easier.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A dispensing gun comprising:
a mix head for combining two fluid components, the mix head having two fluid component inlets and a mixing chamber between the two fluid component inlets;
a purge rod slidably positioned within the mix head, the purge rod having a forward position for preventing flow from the fluid component inlets, and a rearward position allowing flow from the fluid component inlets into the mixing chamber;
an actuator for moving the purge rod between the forward position and the rearward position; and
a joint having a head and a cavity that joins the actuator and the purge rod.

2. The dispensing gun of claim 1, wherein the actuator has an actuator shaft that joins with the purge rod at the joint.

3. The dispensing gun of claim 2, wherein the joint is a ball and socket joint having a ball portion and a socket portion, wherein the head is the ball portion and cavity is the socket portion.

4. The dispensing gun of claim 2, wherein the joint is a ball and socket joint having a ball portion and a socket portion, wherein the purge rod includes the ball portion and the actuator shaft includes the socket portion.

5. The dispensing gun of claim 2, wherein the actuator shaft comprises:
a first shaft end;
a second shaft end;
a shaft surface that extends between the first shaft end and the second shaft end, the shaft surface being radially offset from an actuator shaft centerline longitudinal axis that extends from the first shaft end to the second shaft end; and
the cavity comprising:
an axial slot having a slot width that extends into the actuator shaft along a length through the first shaft end and the shaft surface; and
a socket extending into the axial slot in the actuator shaft through the shaft surface, the socket having a socket width that is larger than the slot width.

6. The dispensing gun of claim 5, wherein the purge rod comprises:
the head having a head width; and
a rod shaft connected to the head, the rod shaft having a diameter that is smaller than the head width and a rod shaft centerline longitudinal axis extending through the middle of the rod shaft;
wherein the head width is larger than the slot width.

7. The dispensing gun of claim 6, wherein the mix head has a bore in which the purge rod is slidably positioned, the bore allowing axial movement of the purge rod, but preventing radial movement of the purge rod, thereby preventing the purge rod from disconnecting from the actuator at the joint during operation of the dispensing gun.

8. The dispensing gun of claim 6, wherein the socket is a round hole and the head is substantially spherical.

9. The dispensing gun of claim 8, wherein the purge rod is joined to the actuator shaft when the head of the purge rod is in the socket of the cavity of the actuator shaft, and the rod shaft is in the axial slot of the cavity.

10. The dispensing gun of claim 9, wherein the purge rod and the actuator shaft are substantially coaxial when the purge rod is connected to the actuator shaft.

11. A dispensing gun comprising:
a handle;
a cylinder attached to the handle;
a reciprocating actuator located inside the cylinder;
a dispense tip attached to the cylinder;
a purge rod slidably positioned in the mix head; and
a joint connecting the purge rod to the reciprocating actuator, the joint having a head and a cavity.

12. The dispensing gun of claim 11, wherein the reciprocating actuator has an actuator shaft that connects to the purge rod at the joint.

13. The dispensing gun of claim 12, wherein the joint is a ball and socket joint having a ball portion and a socket portion, wherein ball portion is the head and the socket portion is the cavity.

14. The dispensing gun of claim 12, wherein the joint is a ball and socket joint having a ball portion and a socket portion, wherein the purge rod includes the ball portion and the actuator shaft includes the socket portion.

15. The dispensing gun of claim 12, wherein the actuator shaft comprises:
a first shaft end;
a second shaft end;
a shaft surface that extends between the first shaft end and the second shaft end, the shaft surface being radially offset from an actuator shaft centerline longitudinal axis that extends from the first shaft end to the second shaft end; and
the cavity comprising:
an axial slot having a slot width that extends into the actuator shaft along a length through the first shaft end and the shaft surface; and
a socket extending into the axial slot in the actuator shaft through the shaft surface, the socket having a socket width that is larger than the slot width.

16. The dispensing gun of claim 15, wherein the purge rod comprises:
the head having a head width; and
a rod shaft connected to the head, the rod shaft having a diameter that is smaller than the head width and a rod shaft centerline longitudinal axis extending through the middle of the rod shaft;
wherein the head width is larger than the slot width.

17. The dispensing gun of claim 16, wherein the dispense tip has a bearing sleeve inside of the dispense tip, the bearing sleeve having a bore in which the purge rod is slidably positioned, the bore allowing axial movement of the purge rod, but preventing radial movement of the purge rod, thereby preventing the purge rod from disconnecting from the actuator at the joint during operation of the dispensing gun.

18. The dispensing gun of claim 16, wherein the socket is a round hole and the head is substantially spherical.

19. The dispensing gun of claim 18, wherein the purge rod is joined to the actuator shaft when the head of the purge rod is in the socket of the cavity of the actuator shaft, and the rod shaft is in the axial slot of the cavity.

20. The dispensing gun of claim 19, wherein the purge rod and the actuator shaft are substantially coaxial when the purge rod is connected to the actuator shaft.
